(19) United States
(12) Patent Application Publication
(10) Pub. No.: US 2011/0239993 A1
(43) Pub. Date: Oct. 6, 2011

(54) DIESEL FEEDSIDE BOOST PUMP

(75) Inventor: Patrick Powell, Farmington Hills, MI (US)

(73) Assignee: DENSO INTERNATIONAL AMERICA, INC., Southfield, MI (US)

(21) Appl. No.: 12/974,256

(22) Filed: Dec. 21, 2010

Related U.S. Application Data
(60) Provisional application No. 61/319,791, filed on Mar. 31, 2010.

(51) Int. Cl. F02M 37/04; F04B 23/14

(52) U.S. Cl. 123/497; 417/199.1

(57) ABSTRACT

A fuel system of a vehicle that delivers fuel to an engine includes a fuel tank, a main fuel pump that pumps fuel to the engine, and a fuel supply line through which fuel flows from the fuel tank to the main fuel pump. Moreover, the fuel system includes a boost pump assembly providing variable pumping of fuel from the fuel tank to the fuel supply line toward the engine.

### CROSS-REFERENCE TO RELATED APPLICATION

This application claims the benefit of U.S. Provisional Application No. 61/319,791, filed on Mar. 31, 2010, which is incorporated herein by reference in its entirety.

### FIELD

The present disclosure relates to using an auxiliary fuel boost pump to direct fuel into a fuel line to aid a main fuel pump in pumping fuel to an engine.

### BACKGROUND

This section provides background information related to the present disclosure which is not necessarily prior art.

In controlling a fuel supply to a diesel engine that is part of a start-stop, idling-stop or hybrid power train, the vacuum generated by a main diesel high pressure pump may be lost or become inadequate upon attempting re-starting of the engine, such as during multiple stops and re-starts of the engine in a short period of time. Thus, the fuel supply delivered to the engine may become interrupted with such multiple stops and starts within a short period of time. What is needed then is a device and method to prevent loss of vacuum in an engine fuel line, or supply of fuel within a fuel line immediately upon starting a vehicle.

### SUMMARY

This section provides a general summary of the disclosure, and is not a comprehensive disclosure of its full scope or all of its features.

A fuel system of a vehicle that delivers fuel to an engine is disclosed. The fuel system includes a fuel tank, a main fuel pump that pumps fuel to the engine, and a fuel supply line through which fuel flows from the fuel tank to the main fuel pump. Moreover, the fuel system includes a boost pump assembly providing variable pumping of fuel from the fuel tank to the fuel supply line toward the engine.

A method of operating a fuel system of a vehicle that delivers fuel to an engine is also disclosed. The method includes pumping a fuel from a fuel tank, through a fuel supply line at a pressure, to the engine with a main fuel pump. The method also includes detecting the pressure in the fuel supply line with a pressure sensor. Moreover, the method includes pumping fuel to the fuel supply line toward the engine with a boost pump assembly when the pressure sensor detects that the pressure falls below a predetermined amount.

Additionally, a diesel fuel system of a vehicle that delivers fuel to a diesel engine is disclosed. The fuel system includes a fuel tank and a main fuel pump disposed outside the fuel tank and that pumps fuel to the diesel engine. The fuel system further includes a fuel supply line through which fuel flows from the fuel tank to the main fuel pump at a pressure. Moreover, the fuel system includes a return line through which excess fuel flows from the main fuel pump to the fuel tank. Additionally, the fuel system includes a return jet pump that is fluidly coupled to the return line and that is disposed within the fuel tank. The return jet pump is operable to pump the excess fuel through the return line, away from the main fuel pump, and into the fuel tank. Also, the fuel system includes a pressure sensor that detects the pressure of the fuel flowing through the fuel supply line and a boost pump assembly disposed in the fuel tank and in fluid communication with the fuel supply line. The boost pump assembly provides variable pumping of fuel from the fuel tank to the fuel supply line to be delivered to the main fuel pump. The boost pump assembly includes a boost jet pump and a boost electrical pump that is operably connected to the boost jet pump. The boost electrical pump pumps fuel only when the pressure sensor detects that the pressure falls below a predetermined amount such that the boost jet pump pumps the fuel from the fuel tank to the fuel supply line only when the pressure sensor detects that the pressure falls below the predetermined amount.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle depicting the general location of an engine and fuel system;

FIG. 2 is a perspective view of a fuel module;

FIG. 3 is a side view of a fuel module depicting the location of a fuel boost pump assembly; and

FIG. 4 is an enlarged view of the fuel module of FIG. 3.

Corresponding reference numerals indicate corresponding parts throughout the several views of the drawings.

### DETAILED DESCRIPTION

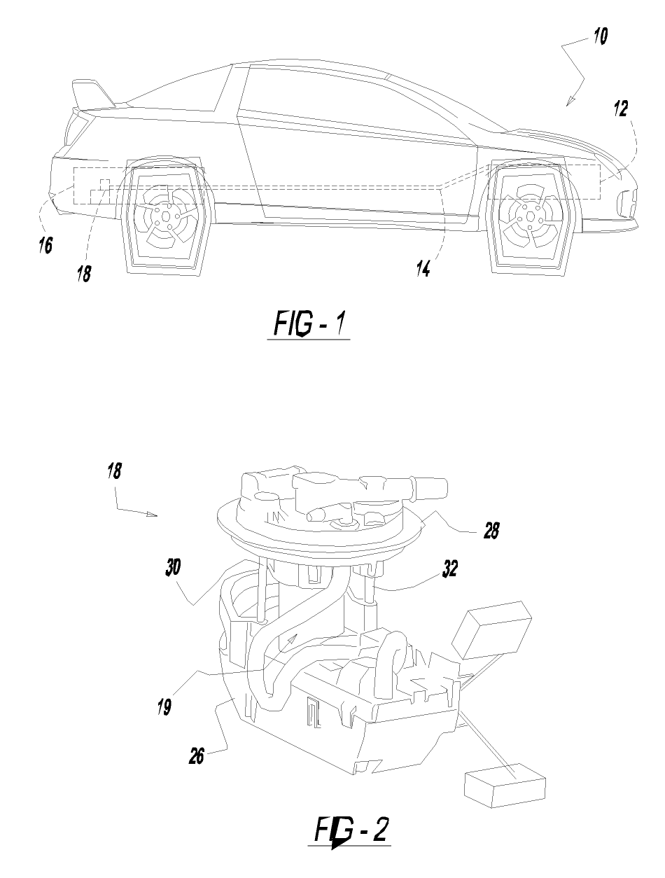

Example embodiments will now be described more fully with reference to the accompanying drawings. With reference to FIGS. 1-4, description of a fuel delivery module for a fuel system, such as a diesel fuel system, in which a feed side boost pump assembly, such as an electric fuel pump, assists in supplying fuel to an engine, such as a diesel engine, will be described. As will be discussed, the fuel delivery module can include a boost pump assembly for providing variable pumping of fuel to the engine. As such, if the vehicle includes a start-stop, idling-stop or hybrid power train, and the engine is stopped and started intermittently, the boost pump assembly can selectively increase the fuel pressure within the fuel delivery line so that the engine can re-start as desired. However, during normal operation of the engine, the main fuel pump can pump the fuel without the aid of the boost pump assembly.

FIG. 1 depicts a vehicle 10 such as an automobile having an engine 12, a fuel supply line 14, a fuel tank 16, and a fuel module 18. Fuel module 18 may be operably coupled, situated in, or suspended within fuel tank 16 and may be submerged in or surrounded by varying amounts of liquid fuel within fuel tank 16 when fuel tank 16 possesses liquid fuel. With reference including FIG. 2, a boost pump assembly 19 is included within fuel module 18. The boost pump assembly 19 may assist in pumping fuel to the engine 12 and filling a fuel supply line 14 (FIG. 1) with fuel by operating or pumping fuel to engine 12, for instance, when engine starting is initiated and/or when pressure in the supply line 14 is relatively low, as will be explained later.

The engine 12 can be a diesel engine that operates on diesel fuel. However, the engine 12 can be of any suitable type other than a diesel engine.

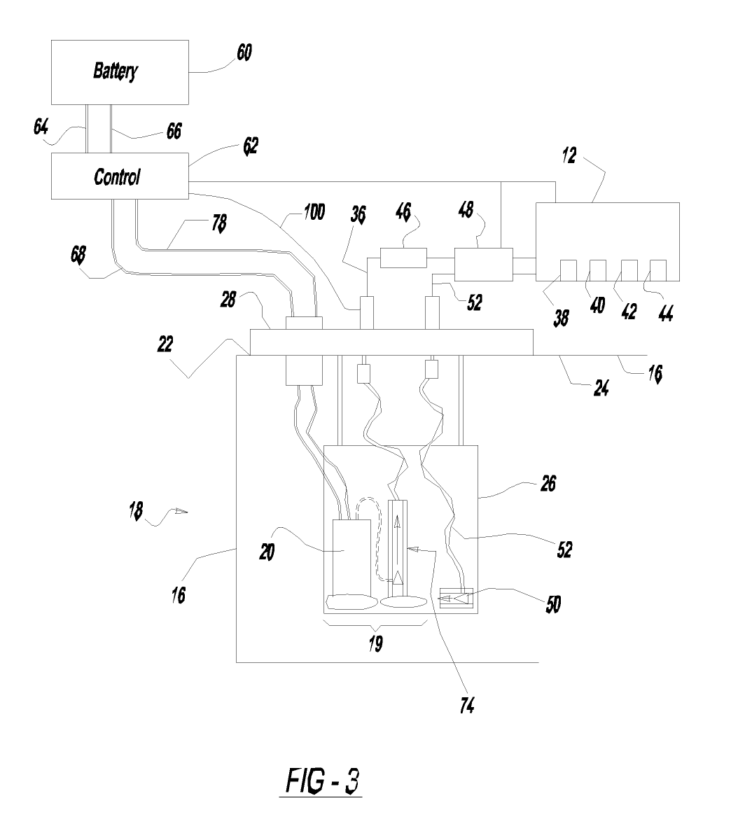

With reference including FIG. 3 fuel module 18 may be lowered through and installed about an aperture 22 in a top wall 24 of fuel tank 16. While fuel module 18 of FIG. 2 depicts a reservoir 26 that is generally horizontally elongated, reservoir 26 may be configured to be generally vertically elongated or cylindrical; however, packing requirements, such as a shape of fuel tank 16 and other vehicle components, for example, may govern the general shape of a fuel module utilized.

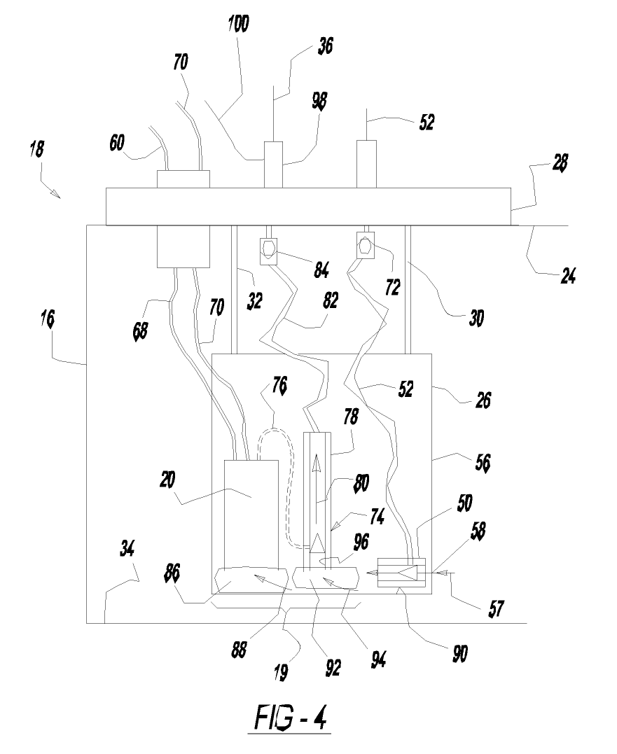

With reference now including FIG. 4, a more detailed explanation of fuel module 18 and its operation will be provided. Fuel module 18 may employ a fuel module flange 28 that mounts to top wall 24 of fuel tank 16. Flange 28 forms a seal, such as with an O-ring, with the top wall 24 and is secured to the fuel tank 16. First and second reservoir rods 30, 32 may secure fuel module reservoir 26 to a bottom interior wall 34 of fuel tank 16, with or without a biasing element such as a spring, as is known in the art. From a top of flange 28, engine fuel supply line 36 protrudes to deliver liquid fuel (e.g., diesel fuel) to engine 12, and more specifically, to a series of engine fuel injectors 38, 40, 42, 44 (see FIG. 3). In supplying fuel from fuel module 18 to engine fuel injectors 38, 40, 42, 44, fuel may pass through a fuel filter 46 and a high pressure fuel pump 48 (i.e., main fuel pump 48). The fuel pump 48 can be disposed outside the fuel tank 16 (e.g., adjacent or attached to engine 12) and can be fluidly connected to the fuel supply line 36. Because fuel pump 48 has sufficient vacuum generating capability, fuel pump 48 may draw fuel directly from fuel tank 16, without pumping assistance from any additional fuel pump. Also, in some scenarios, the boost pump assembly can assist the fuel pump 48 by pumping fuel from the fuel tank 16 toward the engine 12 at predetermined times.

The module 18 can additionally include a return line (e.g., jet pump line 52), which is fluidly connected to the main fuel pump 48 and that extends through the flange 28 and into the fuel tank 16 for returning flow of fuel away from the main fuel pump 48. Also, the module 18 can include a return pump, such as a return jet pump 50. The jet pump 50 can be of a known type and can be disposed within the fuel tank 16. The jet pump 50 can be fluidly coupled to the return line 52 so that the jet pump 50 can pump excess fuel through the jet pump line 52, away from the main fuel pump 48, and back into the fuel tank 16. In other words, because fuel pump 48 is capable of pumping with sufficient pumping pressure, fuel pump 48 may also supply a sufficient volume and pressure of fuel to a jet pump 50 located within reservoir 26.

In operation, jet pump 50 receives fuel from fuel pump 48 only when engine 12 is operating to drive fuel pump 48. Because jet pump 50 operates in accordance with the principles of a venturi, a vacuum is created to draw fuel 57 from outside of reservoir 26, through an orifice 58 in reservoir wall 56 and into an inside of reservoir 26 to maintain fuel within reservoir 26 at all times engine 12 is operating. A jet pump line check valve 72 may be resident in jet pump line 52 to limit flow of fuel away from jet pump 50 toward main fuel pump 48. Specifically, the check valve 72 can permit fuel to flow to the jet pump 50 but will not permit fuel to flow through jet pump line 52 from jet pump 50 towards the main fuel pump 48.

As shown in FIGS. 3 and 4, the boost pump assembly 19 can generally include a boost jet pump 74 and a boost electrical pump 20. The boost jet pump 74 and boost electrical pump 20 can both be disposed within the reservoir 26 of the fuel tank 16 and can be operably coupled together. Moreover, the jet pump 74 can operate according to the principles of a venturi, and the boost electrical pump 20 can be of a known type, such as a turbine pump.

As shown in FIG. 3, the vehicle 10 can also include a controller 62 and a power source, such as a battery 60. The controller 62 can include a processor, computerized memory, software, and other hardware. In some embodiments, the controller 62 can be the vehicle's central electronic control unit (ECU). The battery 60 can ultimately supply power to the boost pump assembly 19 as will be discussed. The battery 60 can be the main battery 60 of the vehicle such that the battery is used for other systems (e.g., powering lights within the vehicle 10, etc.), or the battery 60 can be of any other suitable type.

Specifically, the battery 60 may supply electrical power to the controller 62 using electrical power lines 64, 66, while control module 62 may relay electrical power to boost electrical pump 20 via lines 68, 70. In other words, the control module 62 can control the amount of power that is supplied to the boost electrical pump 20 to thereby control operation (e.g., pumping operation) of the boost pump assembly 19. Control module 62 may also communicate with engine 12 and/or injection pump 48 as part of a method of controlling boost pump assembly 19.

The power supplied to the boost electrical pump 20 may be varied such that boost electrical pump 20 (and boost jet pump 74) pumps at variable times. For instance, the amount of power or voltage supplied to the boost jet pump 74 can be approximately zero when the pressure in the supply line 36 is above a predetermined limit, and the power or voltage supplied can be above zero when the pressure in the supply line 36 is below the predetermined limit. Also, in some embodiments, power or voltage is only supplied when the pressure is below the predetermined limit such that the boost electrical pump 20 (and the boost jet pump 74) pumps and operates only when the pressure in the supply line 36 is relatively low. At other times, the boost electrical pump 20 (and boost jet pump 74) can remain nonoperational and fuel can flow past the boost jet pump 74 by operation of the main fuel pump 48.

More specifically, in controlling fuel supply to a diesel engine, such as engine 12, boost electrical pump 20 may pump and supply fuel to the boost jet pump 74 through a boost pump feed line 76. That is, boost electrical pump 20 may pump fuel into boost jet pump feed line 76 that transports fuel to a boost jet pump 74 and into a boost jet pump tube 78 so that fuel 80, upon exiting boost jet pump tube 78, which may be rigid, may flow into boost pump exit line 82. Also, a check valve 84 can be operably coupled to the fuel supply line 36 (e.g., under module flange 28). The check valve 84 can allow fuel flow from the boost pump assembly 19 toward the main fuel pump 48, and the check valve 84 can limit fuel flow from the boost pump assembly 19. Specifically, the check valve 84 can operate to allow flow only in one direction (i.e., toward the main fuel pump 48).

A sock fuel filter 86 may be attached to a bottom inlet of the boost electrical pump 20 to filter fuel 88 being drawn into boost electrical pump 20 from an area next to a module bottom surface 90. Similarly, a sock fuel filter 92 may be attached to a bottom inlet of the boost jet pump 74 to filter fuel 94 being drawn into boost jet pump 74 from an area next to a module bottom surface 90.

Thus, when boost electrical pump 20 is pumping fuel into boost jet pump feed line 76 and into boost jet pump 74, fuel is being directed into boost jet pump tube 78 at the same time that fuel is being drawn from bottom surface 90 of reservoir 26, such as through orifice 96 at an end of boost jet pump tube 78. Fuel is drawn into boost jet pump 74 using the same or similar venturi principles as jet pump 50, that is, relatively high velocity fuel creates a vacuum to draw fuel into orifice 96 and boost jet pump tube 78.

Boost electrical pump 20 may operate each time engine 12 is started, after a predetermined time that engine 12 has been turned off and engine 12 is attempted to be started, or after a pressure in engine fuel supply line 36 has reached or falls below a predetermined pressure and engine 12 is attempted to be started. Determining the pressure in engine fuel supply line 36 may be determined by using a pressure sensor 98, which may be attached to flange 28 or anywhere in engine fuel supply line 36, that communicates with control module 62, which communicates with boost electrical pump 20 and controls on and off operations of boost electrical pump 20.

Accordingly, when the pressure in the supply line 36 is above the predetermined pressure, the boost pump assembly 19 can remain non-operational and the fuel can flow freely past the boost pump assembly 19. However, if the pressure in the supply line 36 should fall below the predetermined pressure limit (e.g., when the engine 12 is started), power can be supplied to the boost electrical pump 20, and the pressure of fuel in the supply line 36 can be maintained at a relatively high level. As such, the engine 12 can operate as desired, even if the engine 12 is stopped and started repeatedly (e.g., in an electric-diesel hybrid engine).

It will be appreciated that the boost pump assembly 19 can operate according any suitable criteria other than or in addition to the pressure in the supply line 36. For instance, in some embodiments, the boost pump assembly 19 can automatically start whenever a command is input to start the engine 12.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including”, and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A fuel system of a vehicle that delivers fuel to an engine comprising:
a fuel tank;
a main fuel pump that pumps fuel to the engine;
a fuel supply line through which fuel flows from the fuel tank to the main fuel pump; and
a boost pump assembly providing variable pumping of fuel from the fuel tank to the fuel supply line toward the engine.

2. The fuel system of claim 1, wherein the fuel flows through the fuel supply line at a pressure, and wherein the boost pump assembly pumps the fuel when the pressure falls below a predetermined amount.

3. The fuel system of claim 2, further comprising a pressure sensor that detects the pressure of the fuel in the fuel supply line, and further comprising a controller that controls the boost pump assembly to pump the fuel when the pressure sensor detects that the pressure falls below the predetermined amount.

4. The fuel system of claim 2, wherein the boost pump assembly pumps the fuel only when the pressure falls below the predetermined amount.

5. The fuel system of claim 1, wherein the boost pump assembly includes a boost jet pump and a boost electrical pump that are operably connected to each other, and further comprising a power source that provides variable power to the boost electrical pump such that the boost pump assembly provides variable pumping of fuel from the fuel tank to the fuel supply line to be delivered toward the engine.

6. The fuel system of claim 1, wherein the engine is a diesel engine and the fuel is diesel fuel.

7. The fuel system of claim 1, wherein the boost pump assembly is disposed within the fuel tank.

8. The fuel system of claim 1, wherein the main fuel pump is disposed outside the fuel tank.

9. The fuel system of claim 1, further comprising a return jet pump and a return line that are fluidly coupled together, wherein the return jet pump pumps excess fuel through the return line, away from the main fuel pump, and into the fuel tank.

10. The fuel system of claim 9, wherein the return jet pump is disposed in the fuel tank.

11. The fuel system of claim 1, further comprising a feed check valve operably coupled to the fuel supply line that allows fuel flow from the boost pump assembly toward the main fuel pump and that limits fuel flow from the main fuel pump toward the boost pump assembly.

12. A method of operating a fuel system of a vehicle that delivers fuel to an engine comprising:
pumping a fuel from a fuel tank, through a fuel supply line at a pressure, to the engine with a main fuel pump;
detecting the pressure in the fuel supply line with a pressure sensor; and
pumping fuel to the fuel supply line toward the engine with a boost pump assembly when the pressure sensor detects that the pressure falls below a predetermined amount.

13. The method of claim 12, wherein pumping the fuel with the boost pump assembly occurs only when the pressure falls below the predetermined amount.

14. The method of claim 12, wherein the boost pump assembly includes a boost jet pump and a boost electrical pump that are operably connected to each other, and further comprising providing variable power to the boost electrical pump such that the boost pump assembly provides variable pumping of the fuel from the fuel tank to the fuel supply line to be delivered toward the engine.

15. The method of claim 12, wherein the boost pump assembly is disposed within the fuel tank.

16. The method of claim 12, wherein the main fuel pump is disposed outside the fuel tank.

17. The method of claim 12, further comprising pumping excess fuel from the main fuel pump through a return line and into the fuel tank with a return jet pump.

18. The method of claim 17, wherein the return jet pump is disposed in the fuel tank.

19. The method of claim 12, further comprising limiting fuel flow from the main fuel pump toward the boost pump assembly with a check valve.

20. A diesel fuel system of a vehicle that delivers fuel to a diesel engine comprising:
a fuel tank;
a main fuel pump disposed outside the fuel tank and that pumps fuel to the diesel engine;
a fuel supply line through which fuel flows from the fuel tank to the main fuel pump at a pressure;
a return line through which excess fuel flows from the main fuel pump to the fuel tank;
a return jet pump that is fluidly coupled to the return line and that is disposed within the fuel tank, the return jet pump operable to pump the excess fuel through the return line, away from the main fuel pump, and into the fuel tank;
a pressure sensor that detects the pressure of the fuel flowing through the fuel supply line; and
a boost pump assembly disposed in the fuel tank and in fluid communication with the fuel supply line, the boost pump assembly providing variable pumping of fuel from the fuel tank to the fuel supply line to be delivered to the main fuel pump, the boost pump assembly including a boost jet pump and a boost electrical pump that is operably connected to the boost jet pump, the boost electrical pump pumping fuel only when the pressure sensor detects that the pressure falls below a predetermined amount such that the boost jet pump pumps the fuel from the fuel tank to the fuel supply line only when the pressure sensor detects that the pressure falls below the predetermined amount.
